(19) United States
(12) Patent Application Publication
(10) Pub. No.: US 2018/0007208 A1
(43) Pub. Date: Jan. 4, 2018

(54) SYSTEM AND METHOD OF CUSTOMER SERVICE CENTER CALL-BACK

(71) Applicant: Mystate Mobile (2014) Ltd., Petah Tikva (IL)

(72) Inventors: Rony Haim OHAYON, Rehovot (IL); Oshry MAIMON, Shiloh (IL); Ami HANYA, KfarTapuach (IL); Assaf Israel, Shiloh (IL); Zvika STARKMAN, Kfar Saba (IL)

(73) Assignee: Mystate Mobile (2014) Ltd., Petah Tikva (IL)

(21) Appl. No.: 15/541,744

(22) PCT Filed: Jan. 7, 2016
(86) PCT No.: PCT/IL2016/050018

§ 371 Date: Jul. 6, 2017

Related U.S. Application Data
(60) Provisional application No. 62/100,942, filed on Jan. 8, 2015.

(51) Int. Cl. H04M 3/523; H04M 3/42

(52) U.S. Cl. CPC H04M 3/5231; H04M 3/42093; H04M 3/42365

(57) ABSTRACT

A method of indicating to a callee an availability status of a caller, the method includes receiving a request of the caller to be called by the callee, receiving from the caller a unique identifier and an availability status, displaying to the callee the availability status of the caller, and displaying to the caller an availability status of the callee.

### FIELD OF THE INVENTION

The present invention relates to phone call management. More particularly, the present invention relates to a systems and methods for managing phone calls with a customer service call center.

### BACKGROUND OF THE INVENTION

With many technological advances in recent years, waiting time periods for calls to customer service centers are still a source of customer frustration. Customers calling a customer service centers can wait up to half an hour until an operator becomes available to take their call.

While some recent solutions allow a customer to enter a phone number with the service center and request the center to call the customer back when an operator becomes available, typical customer responses to this solution indicate that the center usually calls back when it is least convenient for the customer. Such inefficient manner of customer service consumes valuable time both from the customer, and from the customer service center.

### SUMMARY OF THE INVENTION

There is thus provided, in accordance with a preferred embodiment of the present invention, a method of indicating to a callee an availability status of a caller is provided, the method comprising receiving a request of said caller to be called by said callee receiving from said caller a unique identifier, and an availability status, and displaying to said callee said availability status of said caller.

Furthermore, in accordance with a preferred embodiment of the present invention, the method further comprises displaying to said caller an availability status of said callee.

Furthermore, in accordance with a preferred embodiment of the present invention, the method further comprises automatically initiating a call between said caller and said callee when said availability status of each of said caller and said callee indicate that said caller and said callee are available.

Furthermore, in accordance with a preferred embodiment of the present invention, the method further comprises altering an availability status of said caller upon receipt of a signal that said caller has become available.

Furthermore, in accordance with a preferred embodiment of the present invention, the method further comprises displaying to said caller a position of said caller in an order of calls to be made by said callee.

Furthermore, in accordance with a preferred embodiment of the present invention, said receiving said availability status of said caller comprises receiving a signal as to said availability of said caller, wherein said signal as to said availability of said caller is issued from an input device associated with a communication device of said caller.

Furthermore, in accordance with a preferred embodiment of the present invention, said receiving said availability status of said caller comprises receiving a signal that a communication line of said caller is engaged.

Furthermore, in accordance with a preferred embodiment of the present invention, the method further comprises presenting to said caller a representation of said callee from among a plurality of callees, and providing to said caller a predefined response for delivery to said callee said unique identifier, said request and said availability status of said caller.

Furthermore, in accordance with a preferred embodiment of the present invention, the method further comprises continuously updating said availability status of said caller.

Furthermore, in accordance with a preferred embodiment of the present invention, a communication system for a network is provided, the system comprising a computing device, having a processor and connected to the network, and at least one communication device, connected to the network and capable of communicating the computing device via the network, wherein said processor is configured to receive a signal via the network, said signal including a unique identifier and an availability status of said at least one communication device.

Furthermore, in accordance with a preferred embodiment of the present invention, the system further comprises at least one display configured to display the availability status of said at least one communication device.

Furthermore, in accordance with a preferred embodiment of the present invention, the at least one communication device further comprises a processor configured to receive an availability status of said computing device.

Furthermore, in accordance with a preferred embodiment of the present invention, the at least one communication device further comprises at least one display configured to display the availability status of said at least one communication device.

Furthermore, in accordance with a preferred embodiment of the present invention, said processor of the communication device is configured to initiate a call between said computing device and said communication device upon receipt of a signal that an availability status of said communication device is available.

Furthermore, in accordance with a preferred embodiment of the present invention, the at least one computing device further comprises a memory configured to store the availability status of said at least one communication device.

Furthermore, in accordance with a preferred embodiment of the present invention, the at least one communication device further comprises a memory configured to store the availability status of said computing device.

Furthermore, in accordance with a preferred embodiment of the present invention, the system further comprises at least one sensor that is configured to provide an indication on the availability status of the at least one communication device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a communication system, according to an embodiment of the present invention;

FIG. 2A schematically illustrates the display of a communication device, according to an embodiment of the present invention;

FIG. 2B schematically illustrates the display of a computing device, according to an embodiment of the present invention; and

FIG. 3 shows a flow chart for a caller control communication system, according to an embodiment of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, and components have not been described in detail so as not to obscure the embodiments of the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. In some embodiments, one or more methods of embodiments of the invention may be stored on an article such as a memory device, where such instructions upon execution by for example one or more processors results in a method of an embodiment of the invention. In some embodiments, one or more components of a system may be associated with other components by way of a wired or wireless network. For example one or more memory units and one or more processors may be in separate locations and connected by wired or wireless communications to execute such instructions. Embodiments of the invention may include machine-readable executable code contained in a non-transitory storage medium for a computing device, wherein the executable code, when executed by the computing device, causes the computing device to perform a method of the invention.

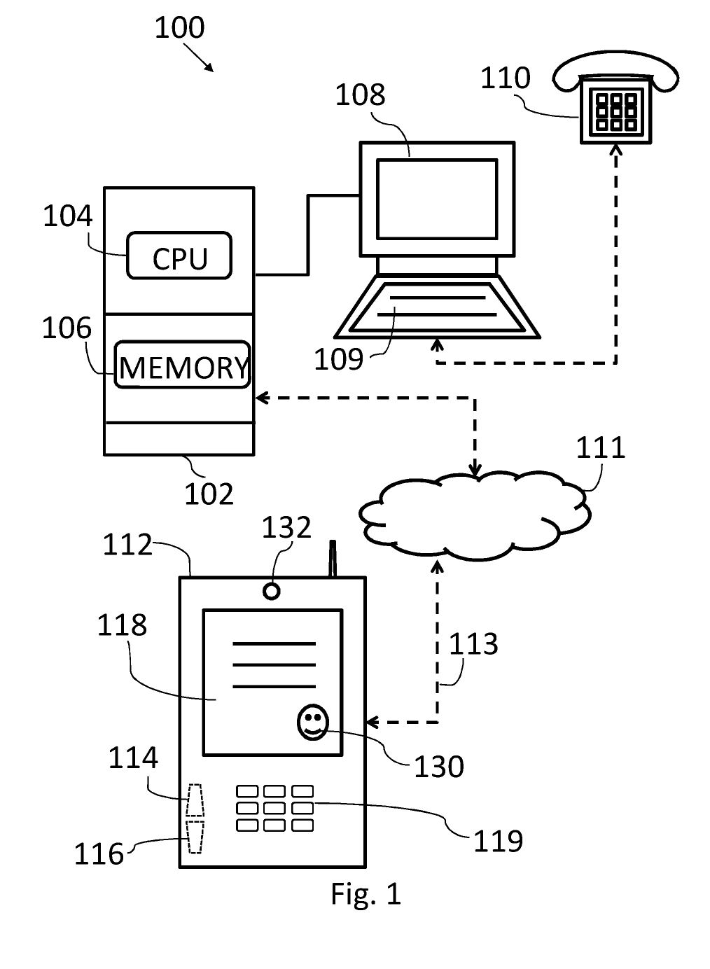

Reference is now made to FIG. 1, which schematically illustrates a communication system (wherein the direction of dashed arrows indicates the direction of information flow), generally designated 100, according to some embodiments of the present invention. In some embodiments of the invention, communication system 100 may include one or more computing devices 102 such as for example a server, which may include one or more processors 104 such as a central processing unit (CPU), and one or more memory units 106. The communication system 100 may further include at least one output display device 108 such as a screen, and also at least one input device 109 such as a keyboard, a touch screen or any other input device, or a combination thereof.

Communication system 100 may further include at least one telecommunication device 110 such as a telephone, cellular telephone, smartphone, voice over internet phone or any other telecommunication device, or a combination thereof. According to some embodiments, system 100 may further include one or more links to a network 111 such as a telephone network, a cellular network or the Internet.

According to some embodiments, communication system 100 further includes a communication device 112 (not illustrated to scale) that may include a smartphone, a computer, a laptop, a tablet or any other communication device, or a combination thereof. Communication device 112 may include one or more processors 114, one or more memory units 116, one or more displays 118 or output means, one or more input devices 119 (e.g. a keyboard or microphone) and one or more network connections 113 (e.g. with a dedicated communication module).

It should be noted that a user may use the communication device 112 in order to communicate with the computing device 102, via the network 111. For example, a customer may use a smartphone 112 to call a customer service center via a cellular network 111, whereby the operator at the customer service center receives call with a laptop 102 connected to a landline telephone 110.

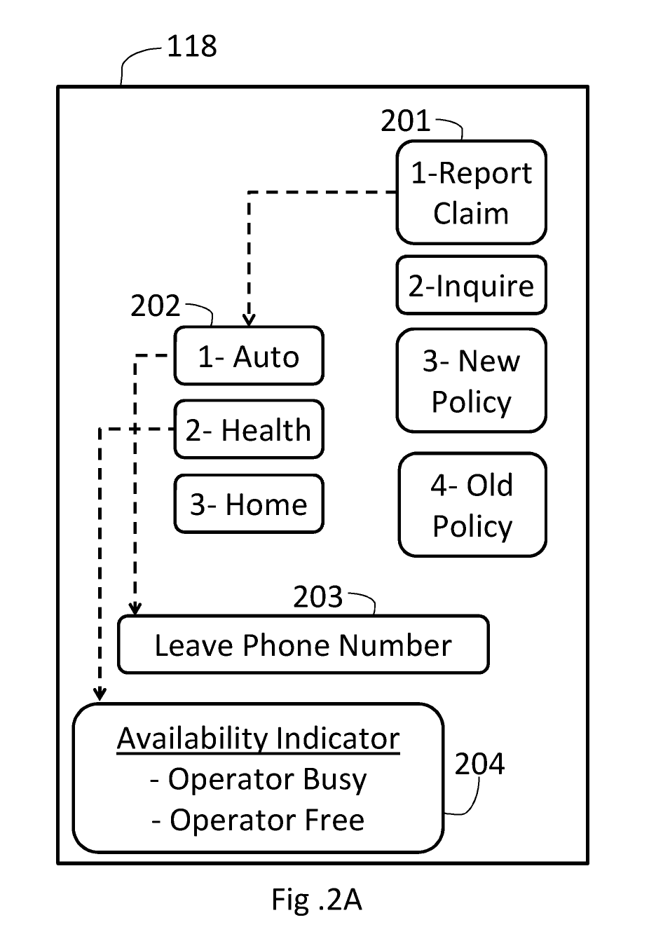

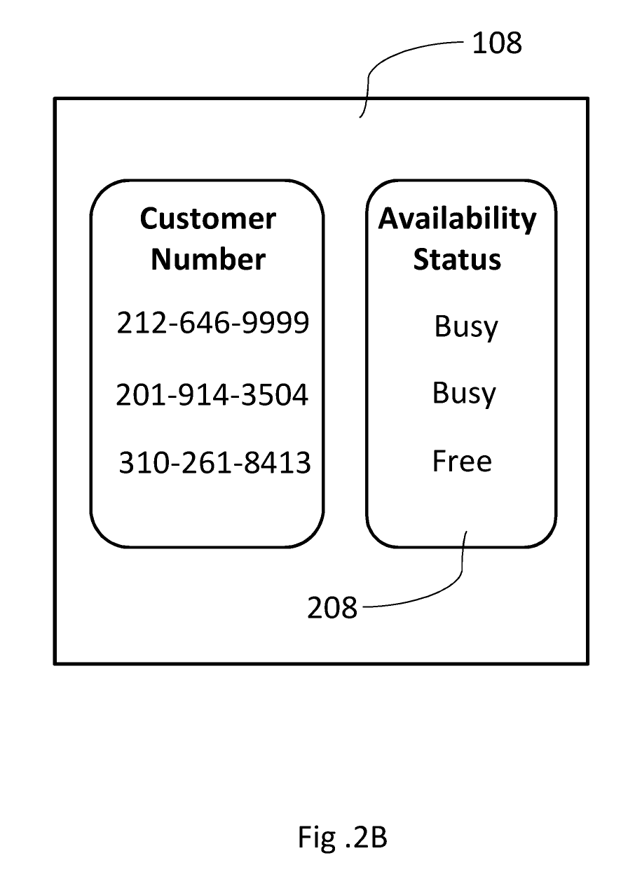

Reference is now made to FIGS. 2A-2B, which show exemplary displays for a user and for a customer service with the communication system, according to some embodiments of the present invention. FIG. 2A schematically illustrates the display 118 of the communication device 112, and FIG. 2B schematically illustrates the display 108 of the computing device 102.

In some embodiments, a user using the communication device 112 may make a call via the network 111, seeking service (or an operator) for example from a customer service center or from any other telephone center that employs people to take calls from users, and that may be connected to or associated with a computing device 102 (for instance as shown in FIG. 1).

Upon generation of the call, according to some embodiments, the user using the communication device 112 may be presented with either a voice description of a menu of options, and/or a visual menu of such options on, for instance, display 118. Such a menu may allow the user to select one or more types of services or operators that the user is seeking on this call. In some embodiments, the user may select a desired option by pressing a corresponding segment on the display 118.

For example, a menu may provide initial options 201 with an audio recording and/or displayed on the display 118: “Press 1 to report a claim”, “Press 2 to inquire about a claim”, “Press 3 to obtain information about a new policy”, “Press 4 to inquire about an existing policy”, etc. If the user selects the first option (i.e. presses 1), the menu may present further options 202, such as “Press 1 to report an auto claim”, “Press 2 to report a health claim”, “Press 3 to report a homeowner's claim”, etc. A user may select for example 1 to report a claim, and 2 to report a health claim. Optionally, the user may be told (e.g. by an audio recording) that all operators are currently busy, and may be offered an option 203 to enter a phone number and that an operator will return his call as soon as possible.

The user may also be offered an option to send, and/or send and receive an availability indicator 204. The availability indicator 204 may present to the user an indication of whether the operator at the telecommunication device 110 (e.g. a phone), for instance who handles health claims, is either available for a call or busy. In some embodiments, the user may use a user availability indicator 208 (as shown in FIG. 2B) in order to indicate to the operator when the user is available for a call.

According to some embodiments, the computing device 102 may continuously monitor for a signal or message, for instance from the network 111, that the telecommunication device 110 (e.g. a phone) or rather that the operator of the telecommunication device 110 is either available or busy. Such a signal may, for instance, be transmitted to the display 118 of the communication device 112, for instance via the network 111, in order to activate and/or alter the state of the availability indicator 204 so as to reflect the state of the operator of the telecommunication device 110.

In some embodiments, the selection by the user to leave a number 203 and/or user availability indicator 208, may cause a signal to be sent to the display 108 of the computing device 102 where there may be listed the phone number of the user who left the message, and optionally a user availability indicator 208 of the status or readiness of the user to accept a call from the operator.

In some embodiments, if both the operator and the user are available for a call at the same time, for instance as indicated by the availability indicators 204, 208 the system may automatically generate a call between the user and the operator, and/or send a signal to one (or both) of the user and the operator that they are both available for the expected call. In some embodiments, a system and method of receiving, storing and transmitting a status of cellular telephone and one or more landline or other communication line may be performed. Other ways of tracking, storing and indicating a usage or availability of a communication device may also be used.

According to some embodiments, in order to provide the user availability indication 208, the system 100 may utilize built-in sensors within the communication device 112. For example, the communication system 100 may utilize physical sensors (such as accelerometers, motion sensors, etc.), and/or software-based sensors or device sensors (such as ringer on/ringer off, screen on/screen off, device on/device off, etc.). These sensors may provide an indication when the user uses the communication device 112, for instance when the motion sensors detect movement compatible with the user holding the communication device 112 or sensors indicating connection to a communication network, and also that the user is available to receive a call.

In some embodiments, communication system 100 may receive a signal from for example a network operating system that the communication device 112 is no longer in contact with a network, and such signal may automatically trigger a change in a status of the communication device 112, as may be stored on memory 106, to Not-Available′.

According to some embodiments, a user may input a status of the communication device 112 (or of the user) by way of, for instance, input device 119, and/or such status may be inputted automatically by a dedicated sensor associated with the communication device 112. Such a delivery of status information may be initiated by the user of communication device 112, or by the processor 114 associated with device 112. A status or indication of such status may be transmitted from communication device 112 by via network 114 or by some other network or signal on, for example, a periodic basis or in response to a trigger or signal.

In some embodiments, a dedicated memory, for instance in a server or a cloud based network, may collect status information from one or more devices and may store such status information in association with an identifier of the device. For example, a telephone number, SIM number or other unique identifier of the communication device 112 may be stored in, or in association with processor 114, be delivered to the server and stored in memory 106 of the computing device 102.

A status information or indication may be delivered for example via network 111 to memory 106, and associated with the unique identifier of device 112 that may also be stored in or associated with memory 106. Unique identifiers of the computing device 102 may also be associated with the communication device 112 as being authorized to see or gain access to status information of the communication device 112 that may be stored on memory 116, such that a group of authorized devices may be associated or created on for example memory 106 as having access to status information of one or more members of such group. In some embodiments, members of a group to which the user or device belongs may be shown or made available for display on display 118. For example, a dedicated user interface on communication device 112 may show or list a group of devices or users, as well as an indication of a status of one or more of such users or devices. In some embodiments a consent or permission may be required by the communication system 100 in order for the communication device 112 or user to join a group or otherwise to be permitted to receive or send status information from another device.

A status information may be or include data such as ‘available to take a call’, ‘busy on a call’, ‘phone off’, ‘please call’, or any other status that may be defined for example by a user or may be provided for selection by way of for example a menu that may appear on the display 118. One or more of such statuses may be associated with for example an icon, color or any other indication as may appear on display 118, and as may be selected by a user or provided by the communication system 100.

In some embodiments, on an occasional, periodic or initiated basis, a signal may be sent to the communication device 112 by for example the network 111. Such signal may include for example, updated status information of one or more users or devices 102, 112 that are in a group associated with the computing device 102. Such signal may update or change the status indication, color, message or icon that is presented on display 108 of the computing device 102 so that the updated status information is displayed.

In some embodiments, a signal may be sent to a user or communication device 112 upon for example a change in status of the operator or computing device 102. For example a computing device 102 may issue a signal requesting that it be notified when a status of the communication device 112 goes from ‘busy’ to ‘available’, or that there is some other change in a status of one or more other devices. In some embodiments, the communication system 100 may request a status setting from the computing device 102 on a regular or periodic basis, and may store an indication of such status setting in the memory 106.

In some embodiments, a memory on the computing device 102 may store or cache a time of a most recent update of availability status indicators to the computing device 102, and also list of status indicators that have changed between a current update time and such last time.

In some embodiments, the amount of data required to be transmitted from to the computing device 102 may also be reduced by storing on the computing device 102 a reference number associated with an availability status, and by transmitting only the reference number as an indicator of the status to be displayed with the associated identifier of a name on a contact list. Optionally, updates or changes to status indicators may be delivered to the device 102 in an encoded form, and such delivered data may be encoded on the computing device 102 for translation into changes in status indicators.

In some embodiments, an operator may issue a command to alert him through a signal from the computing device 102 of a change in the availability status of one or more customers. For example, an operator of device 102 may see that a communication device 112 on a customer list is shown with a ‘busy’ indicator. The operator may signal the communication system 100 to alert him by way of device 102 when the availability status of the communication device 112 changes, or specifically changes to ‘available’ or ‘please call me now’. Upon such a change in the availability status of the communication device 112, a signal may be sent to the computing device 102. Optionally, a call may then be automatically executed between the communication device 112 and the computing device 102.

In some embodiments, if the communication device 112 is not enrolled in a communication method or system such as the one described herein, then a short message service (SMS) may be automatically sent to such communication device upon a change in the availability status of the operator of the computing device 102. For example, if a customer, not associated with the communication system 100, tries to reach an operator of a call service working with the communication system 100, an SMS may be automatically sent to the customer with an indication of the operator's availability status as is saved on the computing device 102. Such SMS may in some embodiments include data to allow the customer to join the communication system with the communication device 112 (for instance an SMS with a download link). In response to the SMS or some other signal, the customer may request that the system for example alert the operator that the customer tried to contact him, and/or connect to the operator of the computing device 102 (or otherwise alert) when the operator becomes free or available to take a call.

It is appreciated that embodiments of the invention may include a system that has or is associated with a processor, a memory, a connection to one or more networks and a display. A processor may be configured to receive a signal from for example a caller (e.g. a customer), where such signal includes a unique identifier such as telephone number, or VOIP user name of the caller. The signal may have been sent in response to the caller indicating to a processor 104 that he wishes to speak to someone such as an operator (being a “callee”) that may have been selected from a menu. The processor 104 may also receive an availability status of the caller and a link to a memory or remote device that optionally receives and stores an indication of an availability status of the caller. One or more processors may issue a signal to display 108 to the callee an indication of the availability status 208 of the caller at one or more times following the caller's delivery of its signal. In some embodiments, the processor 104 may issue a signal to display 118 to the caller an availability status 204 of the callee.

In some embodiments, the processor is configured to initiate a call between the caller and the callee upon receipt of a signal that an availability status 204, 208 of each of the caller and the callee has changed to available, or free to accept a call.

In some embodiments, the processor 104 may be configured to issue a signal to display to the caller a position of the caller in a list with order of calls, to be responded to by the callee. For example, the processor may deliver to the caller's display 118 an indication of the number of calls that are in line for the callee to make before the callee calls the caller.

In some embodiments the processor 104 may be configured to deliver to the caller a predefined response for delivery to the callee of the unique identifier and the availability status 204. For example, a processor may deliver an icon or button indicator that may be pressed by the caller, whereupon such pressing, the caller's communication device 112 delivers its contact info (e.g. phone number) to the callee, and delivers a link to a memory 116 to which may deliver and store the caller's availability status 208.

In some embodiments, the communication system 100 may collect and detect a language setting of the communication device 112, and may direct a call from a user of communication device 112 to a customer service representative associated with the computing device 102 who speaks such corresponding language.

In some embodiments, when a caller communication device 112 dials a callee who is recognized by computing device 102 such as a server, a pop-up may appear on the display 118 of communication device 112 to indicate for example an availability status of the callee. Such pop-up or screen icon may include a chat function that may allow the user of communication device 112 to chat with the customer service center, and/or with other callers who are waiting to be served by the center.

Referring back to FIG. 1, according to some embodiments, such pop-up screen or other displayed content may also include for example an icon, or function selection button, or indicator to allow the caller to activate a function that may have been selected by the callee. For example, a caller makes a call on communication device 112 to a callee within a branch of a bank. In some embodiments, an icon 130 or any other indicator may appear, or be shown, or may pop-up on display 118 of the communication device 112. The icon or function may be selected by the callee's bank branch, and when the caller selects the icon, there may be shown on display 118 a real time, live image of the bank branch and the line for service at a teller (e.g. with video streaming from a camera within the bank). This may allow the caller to see in real time the waiting time for service at the bank branch.

Other functions may be selected by a callee and associated with at least one icon 130 or function buttons that pop up on the display 118 of the caller. For example, an icon 130 may allow a user to press and see the hours of operation of the bank branch as such will be transmitted to and displayed on display 118, see a summary of the account balance of the caller at the bank branch, pay a bill owing by the caller from the account of the caller at the bank branch, receive promotional offers from the bank branch or perform other functions. In some embodiments, icon 130 may activate a function on the communication device 112, such as for example a built-in camera 132 (still or video) of communication device 112, so that when so activated, camera 132 of communication device 112 may capture one or more images in an area of communication device 112 and transmit such images in real time to the network or to a device associated with the callee. For example, an emergency services system may include a function icon 130, so that when a call is placed to the emergency number, an icon 130 appears on display 118 of communication device 112 that activates one or more of a microphone and camera 132 of communication device 112 and then transmits the collected sound and/or images to the callee. Other function icons 130 may be selected by a callee and presented to a caller device 112 when such device calls callee.

In some embodiments, a user may input into the communication device 112 his own status, such as ‘busy’, ‘sleeping’ or the like, and an availability indication of such status may appear as associated with his idenfication as it is stored in the contact list of others. In some embodiments, a status of a user of communication device 112 may be for example ‘interested in buying a new refrigerator, call me at 5:30 PM to discuss’. Such status may be inputted from, for example, a template of statuses or a drop-down list of statuses, or may be inputted manually. This status of a user of communication device 112 may be conveyed for example to relevant stores or catalogues that sell refrigerators along with an indication of a time to call the user of the communication device 112. Other statuses and other indications or requests may also be used.

In some embodiments, a call center working with computing device 102 may want to call a large number of contacts, and an automatic dialing function may dial one or more of the numbers to be called, and may pass the call to an operator when a call is answered. Once the operator has completed the call that was passed to him by the automated function, an automated process may select a next call to be dialed that has been answered, and may pass such next answered call to the operator who may then speak with the customer (i.e. now the callee). In this way, an operator may use a function to dial several numbers that are to be called, and may receive a call passed to him only once the call has been actively answered by a person.

In some embodiments, a telephone number that is stored in a contacts list of a user's communication device 112 (e.g. in the memory of a phone) may be associated with a network identifier, such as a TCP/IP number, a SIM number or some other identifier by which the device is recognized by a data network. The name of the contact as well as his telephone number and the network identifier number may all be associated with each other in the telephone contact list stored in the memory 116 of the communication device 112, and optionally in a remote server. A user may thereby input into a function for example one of a name, telephone number or network identifier number, and instruct the communication device (or the server) to place a call over the data network, the cellular network or the telephone network in order to reach the desired contact. Optionally, there may be no need to input one or either of the network identifier or the telephone number of the contact in order to place the call, since the name of the contact may be identified with both numbers. Further, such functions may be instructed to contact the desired contact over the line or path that is cheapest at the time (e.g. over a particular cellular network), that provides the best reception, or that meets some other predefined criteria.

In some embodiments, a callee may subscribe to, for example, an answering service so that calls made to the callee are passed to a human operator so that callers may leave a message for the callee with a operator. Optionally, the callee may select a function as, for example, ‘answering service’, and such selected status may trigger an instruction at for example computing device 102 in order to pass all calls to the callee directly to the manned answering service. Such immediate passing of calls may alleviate the typical situation where a telephone call first rings several times at the dialed number before it is passed to the answering service. In some embodiments, this function may allow the call to be transferred directly upon dialing to the answering service. Further, the callee, such as, for example, a doctor whose patients called him in the office and were answered by an answering service, may be able to access a list of the telephone numbers or names of callers who called and left a message with the answering service. A function of an embodiment of communication system 100, may deliver a list of the calls to the office that were forwarded by the system 100 to the answering service, and may also call back one or more of such callers when the doctor is ready. In some embodiments, the communication system 100 may generate one or more of such call backs when the status of such callers is indicated as being available to receive a call, such as a call from the doctor.

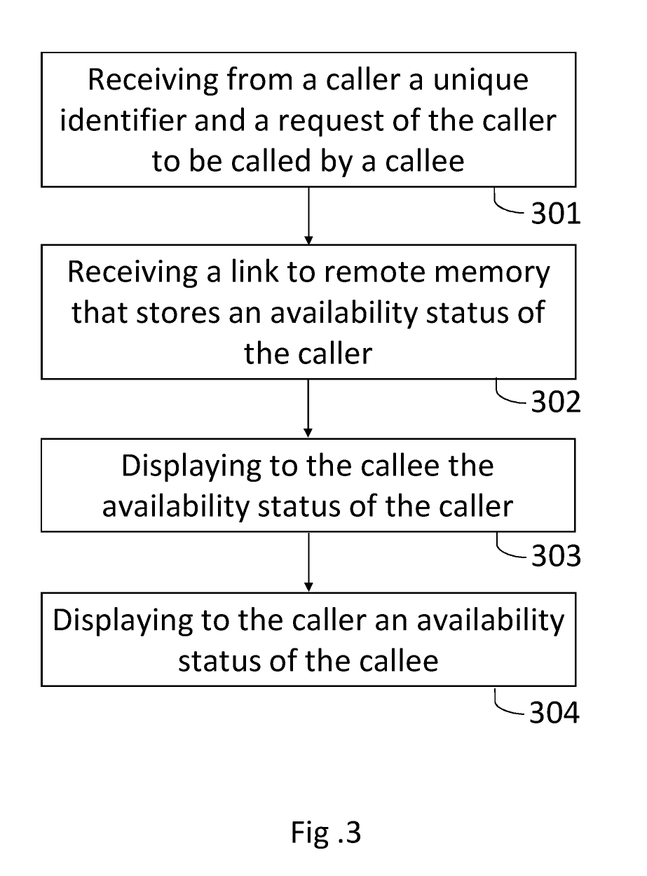

Reference is now made to FIG. 3, which shows a flow chart for a caller control communication system, according to some embodiments of the present invention. Embodiments of the invention may include a method of indicating to a callee an availability status of a caller 208, where the method may include as in block 301, receiving from the caller a unique identifier of the caller and a request of the caller to be called by a particular callee. Embodiments of the method may also include as in block 302, receiving a link to remote memory 116 where is stored an availability status of the caller. Embodiments of the invention may include as in block 303, displaying 108 to the callee the availability status of the caller 208, and as in block 304, displaying 118 to the said caller an availability status of the callee 204.

Embodiments of the invention may include automatically initiating a call between the caller and the callee when an availability status of each of them indicates that each or both (are available for a call.

Embodiments of the invention may include altering an availability status 208 of the caller upon receipt of a signal that the caller has become available. For example, a caller may leave his unique identifier and request for a call with the operator, and then use the line of the telephone for a different call, or may otherwise indicate his unavailability for a call from the callee. At a later time, the caller may be available, and upon receipt of a signal of such availability, the availability indicator displayed 108 for the callee may switch from unavailable to available and initiate a call.

Embodiments of the invention may include displaying on a display of the caller 118 a position of the caller in an order of calls to be made by the callee before it is the turn of the caller to be called by the callee.

Embodiments of the invention may include receiving an indication of the availability status 208 of the caller upon receiving a signal from an input device 119 of the caller such as a keyboard or touch screen associated with the caller.

Embodiments of the invention may include receiving a signal that a communication line of the caller is engaged, or that the caller is unavailable for a call even though such communication line is not engaged, such as for example if the user is sleeping, or otherwise occupied and not interested in being bothered.

Embodiments of the invention may include presenting to the caller a representation of the callee from among several callees. For example, a representation of several operators may be presented to the caller, and the caller may select one or more of the presented operators. The caller may be provided with a predefined response, such as a button to be pressed for delivery to the callee of one or more of the callers' telephone number, and/or the request and availability status 208.

Unless explicitly stated, the method embodiments described herein are not constrained to a particular order in time or chronological sequence. Additionally, some of the described method elements may be skipped, or they may be repeated, during a sequence of operations of a method.

Various embodiments have been presented. Each of these embodiments may of course include features from other embodiments presented, and embodiments not specifically described may include various features described herein.

1. A method of indicating to a callee an availability status of a caller, the method comprising:
receiving a request of said caller to be called by said callee;
receiving from said caller a unique identifier, and an availability status;
displaying to said callee said availability status of said caller; and
automatically initiating a call between said caller and said callee when said availability status of each of said caller and said callee indicate that said caller and said callee are available.

2. The method according to claim 1, further comprising displaying to said caller an availability status of said callee.

3. (canceled)

4. The method according to claim 1, further comprising altering an availability status of said caller upon receipt of a signal that said caller has become available.

5. The method according to claim 1, further comprising displaying to said caller a position of said caller in an order of calls to be made by said callee.

6. The method according to claim 1, wherein said receiving said availability status of said caller comprises receiving a signal as to said availability of said caller, wherein said signal as to said availability of said caller is issued from an input device associated with a communication device of said caller.

7. The method according to claim 1, wherein said receiving said availability status of said caller comprises receiving a signal that a communication line of said caller is engaged.

8. The method according to claim 1, further comprising:
presenting to said caller a representation of said callee from among a plurality of callees; and
providing to said caller a predefined response for delivery to said callee said unique identifier, said request and said availability status of said caller.

9. The method according to claim 1, further comprising continuously updating said availability status of said caller.

10. A communication system for a network, comprising:
a computing device, having a processor and connected to the network; and
at least one communication device, connected to the network and capable of communicating the computing device via the network,
wherein said processor is configured to receive a signal via the network, said signal including a unique identifier and an availability status of said at least one communication device, and wherein said processor of the communication device is configured to initiate a call between said computing device and said communication device upon receipt of a signal that an availability status of said communication device is available.

11. The system according to claim 10, further comprising at least one display configured to display the availability status of said at least one communication device.

12. The system according to claim 10, wherein the at least one communication device further comprises a processor configured to receive an availability status of said computing device.

13. The system according to claim 12, wherein the at least one communication device further comprises at least one display configured to display the availability status of said at least one communication device.

14. (canceled)

15. The system according to claim 10, wherein the at least one computing device further comprises a memory configured to store the availability status of said at least one communication device.

16. The system according to claim 10, wherein the at least one communication device further comprises a memory configured to store the availability status of said computing device.

17. The system according to claim 10, further comprising at least one sensor that is configured to provide an indication on the availability status of the at least one communication device.
